(19) United States
(12) Patent Application Publication
(10) Pub. No.: US 2020/0114811 A1
(43) Pub. Date: Apr. 16, 2020

(54) Method and Device for Reprogrammable Electrical Power System Control

(71) Applicants: MARK JONATHAN ATKINS, SANTA CRUZ, CA (US); ANDREW JOHN GRISBROOKE, Nuthampstread (GB)

(72) Inventors: MARK JONATHAN ATKINS, SANTA CRUZ, CA (US); ANDREW JOHN GRISBROOKE, Nuthampstread (GB)

(21) Appl. No.: 16/158,220

(22) Filed: Oct. 11, 2018

(51) Int. Cl. B60Q 1/34; B60R 16/033

(52) U.S. Cl. CPC B60Q 1/34; B60Q 1/52; B60R 16/033

(57) ABSTRACT

A customization control system includes, and a method, applies reprogramming a logic device by means user actuated elements of an electrically integrated system. The logic device only accepts reprogramming when the system is in a safe mode, e.g., in a non-operating state. One version is applied as an after market kit that avoids aspects of a factory-supplied control system, wherein a controller is communicatively coupled with both one or more user actuated input elements and one or more output elements, whereby the controller directs the behavior of the output elements in response to signals received from the user actuated input elements and without intermediation of a native control system of a comprising product or system. The controller may be programmed with a default mode and/or an override priority, whereby the behavior and/or state of the output elements is directed by the controller without regard to reprogrammed instructions.

### FIELD OF THE INVENTION

The present invention relates generally to devices and methods for customizing output devices of electrically coupled elements. More particularly the present invention relates to devices and methods that

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Many electrically powered products have user controls and output modules, wherein these systems are programmed or otherwise structured to energize or direct the behavior of one or more output modules in accordance with the inputs received from the user controls. Certain of these products permit user customizations, whereby a user or a technician may reprogram a particular instance of a product to vary its behavior in response to input signals as opposed to the factory settings established by a manufacturer or seller of the product. Yet the prior art fails to optimally provide a method or device that enables reprogramming, to include reconfiguration, of a system by providing and applying an additional control system that enables customization techniques that include at least partially deriving reprogramming instructions, to include reconfiguration instructions or commands, from signals generated by one or more user actuated control devices of the product.

### SUMMARY AND OBJECTS OF THE INVENTION

Towards these objects and other objects that will be made obvious in light of the present disclosure, a device and method are disclosed that enable the modification of responses to signals detected by an electrically integrated system. In a first embodiment of the method of the present invention (hereinafter, “the invented method”) a plurality of electrical and/or electronic components are communicatively coupled and configured or programmed to exhibit set responses upon receipt of one or more preselected signals. In accordance with the invented method, the plurality of electrical and/or electronic components (hereinafter; “the system”) is affected by a logic circuit that is adapted to determine and dynamically alter the state of one or more output elements of the system. Under one or more certain conditions, the logic circuit interprets signals generated by user input elements to program and/or reprogram the logic circuit itself. The logic circuit may be native to the system and/or may be supplied in whole or in part as an additional element that is communicatively integrated with the system before or after a configuration of the system has been completed.

In accordance with the invented method, the present invention (hereinafter, “the invented device”) includes a reprogrammable logic capability that may be originally native to the system and is inventively accessed and applied by the invented method or may be supplied by an introduction and communicative integration of a reprogrammable logic circuit, wherein the newly integrated logic circuit was not accessed and/or was not present when the system was originally configured.

In one optional aspect of the invented method, the system exhibits two or more states of readiness, wherein the logic circuit is disabled from being programmed or reprogrammed when the system is in a first state and/or the logic circuit is enabled to be programmed when the system is in a second state. In certain preferred embodiments of the present invention, the system is organic to a motorized vehicle and the logic circuit is disabled from being programmed or reprogrammed when the vehicle is in a state of being enabled for internally powered motion and/or the logic circuit is enabled to be programmed when the system is in an alternate state of being disabled for internally powered motion.

In another alternate preferred embodiment of the invented system, user actuated elements are communicatively coupled with the logic circuit and signals are applied to and by the logic circuit to reprogram itself or other accessible logic elements, whereby output devices that are placed under at least partial control of the circuit are energized and or exercised in accordance with (a.) the reprogramming signals received by the logic circuit, and (b.) signals received by the logic circuit after this reprogramming.

In another optional aspect of the invented method, the invented device retains a default programming to which the logic circuit will again apply upon the occurrence of predetermined commands, signals or conditions. In yet another optional aspect of the invented system, the logic circuit, upon receipt or detection of a pre-established signal or condition, overrides a process of directing an output element in accordance with recently received signals and directs the output element to exhibit an alternately prescribed state, for example but not limited to, the logic device transition a turn signal element state from (a.) a brake light indication state directed by the logic circuit upon the turn signal element in response to receipt of a brake engagement signal, to (b.) a turn signal light indication directed by the logic circuit upon the turn signal element in response to receipt of a turn signal engagement signal.

In various alternate preferred embodiments of the invented method, signal emitting elements that are applied to reprogram the logic circuit may include or be comprised within, but are not limited to, a user actuated pulse generator, a turn signal actuator, manually actuated brake control, a manually actuated clutch control, a manually actuated gear switch control, a hazard light control actuator, a fog light control actuator, a high beam light actuator, and/or other suitable signal generating electronic elements known in the art. Alternatively, optionally or additionally, the logic circuit may comprise or be communicatively coupled with an electrical charge storage battery (hereinafter, a or the “battery”), an accelerometer, an ignition module and/or a system state indicating element that indicates a state of a system by exhibition an electrical energy state or output as communicated to the logic circuit.

Additionally, optionally or alternatively, the logic circuit may be deployed or enabled in still other alternate preferred embodiments of the invented method to affect or determine (a.) the intensity of output of light emitting elements, to include but not limited to light emitting diodes, a frequency of intermittent light emission, e.g., blinking, of one or more light emitting elements, and/or the instantaneous color of light emitted from a light emitting module.

Additionally, optionally or alternatively, the invented device may include or be coupled with a reset logic that provides a default logic to be applied, regardless of a current reprogrammed state of the logic circuit, (a.) to direct the states and behavior of one or more output devices, and/or (b.) to transfer electrical power to energize the light-emitting element in a constant state or intermittently.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

These, and further features of the invention, may be better understood with reference to the accompanying specification and drawings depicting the preferred embodiment, in which:

FIG. 1 is a schematic of an exemplary system as released into the stream of commerce;

FIG. 2A is a schematic of the exemplary system of FIG. 1 and with an invented control system integrated therewith;

FIG. 2B is a schematic of the exemplary system of FIG. 1 and with an invented control system integrated therewith;

FIG. 2C is a block diagram of an output signal table as stored in the controller of FIG. 1 and/or the reprogrammable controller of FIG. 2A and that is applied in step 3.32 of FIG. 3B;

FIG. 2D is a block diagram of a default values table as stored in the controller of FIG. 1 and/or the reprogrammable controller of FIG. 2A and that is applied in step 3.08 of FIG. 3A;

FIG. 2E is a block diagram of an output element identification table as stored in the controller of FIG. 1 and/or the reprogrammable controller of FIG. 2A and that is applied in step 3.10 o of FIG. 3A;

FIG. 2F is a block diagram of an energy level table as stored in the controller of FIG. 1 and/or the reprogrammable controller of FIG. 2A and applied in step 3.18 of FIG. 3A;

FIG. 2G is a block diagram of an output signal pattern table as stored in the controller of FIG. 1 and/or the reprogrammable controller of FIG. 2A and applied in step 3.22, 3.40, 3.42 and 3.44 of FIG. 3B;

FIG. 2H is a block diagram of an output signal pattern table as stored in the controller of FIG. 1 and/or the reprogrammable controller of FIG. 2A and applied in steps 3.32 of FIG. 3B;

FIG. 3A is a flow chart of a process of reprogramming the invented control system of FIG. 2;

FIG. 3B is a flow chart of a process of the invented control system of FIG. 2 performing in accordance with the reprogramming executed in an instantiation of the flow chart of FIG. 3A;

### DETAILED DESCRIPTION

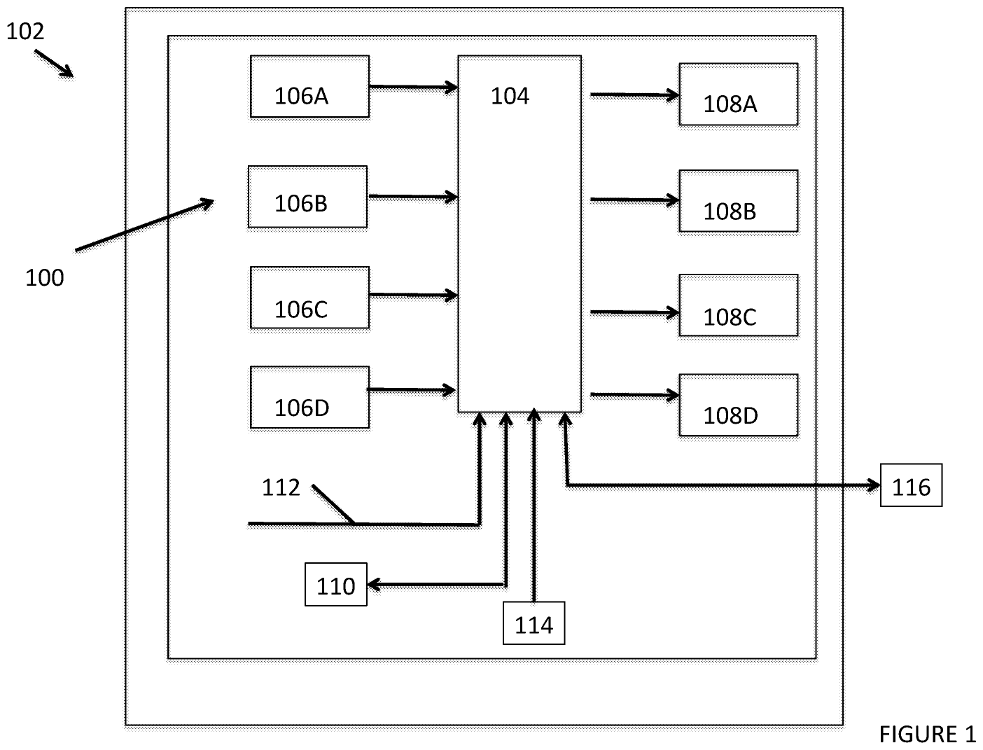

Referring now generally to the Figures and particularly to FIG. 1, FIG. 1 is a block diagram of an exemplary electronic control system 100 (hereinafter, “the first system” 100) released into the stream of commerce within a product 102 comprising aspects of information technology, such as a smart household appliance, or environmental control system, or a motorized vehicle. The first system 100 includes a controller 104 coupled with a plurality of user actuated input elements 106A-106D and a plurality of output elements 108A-108D, and a communications interface 110.

Each user actuated input element delivers signals to the controller 104. Each output element 108A-108D is directed in behavior and state by signals provided from the controller 104. A light emitting element 108A receives electrical power via a power line 112 that electrically couples the controller 102 and the light emitting element 108A, whereby the controller 102 causes the light emitting element 108A to intermittently emit light energy as a consequence of receiving controlled pulses or varied levels of electrical power as controllably enabled by the controller 102.

Where the product 100 is a motorized vehicle, one or more of the plurality of user actuated input elements 106A-106D of the first system 100 may be or comprise a turn signal actuator, manually actuated brake control, manually actuated clutch control, a manually actuated gear switch control, a hazard light control actuator, a fog light control actuator and/or a high beam light actuator.

The first system 100 may further include an operational state indication module 114 that is adapted to provide a product status signal to the controller 104 that indicates whether the product 102 is in an operating state during which the controller 104 may programmed or reprogrammed, to include reconfigured.

It is understood that the controller 104 of certain products 102 is enabled for a reprogramming of the controller 104 itself by means of communication of an external computer 116 with the controller 104 via the communications interface 110 to enable the first system 100 to perform one or more aspects of the invented method.

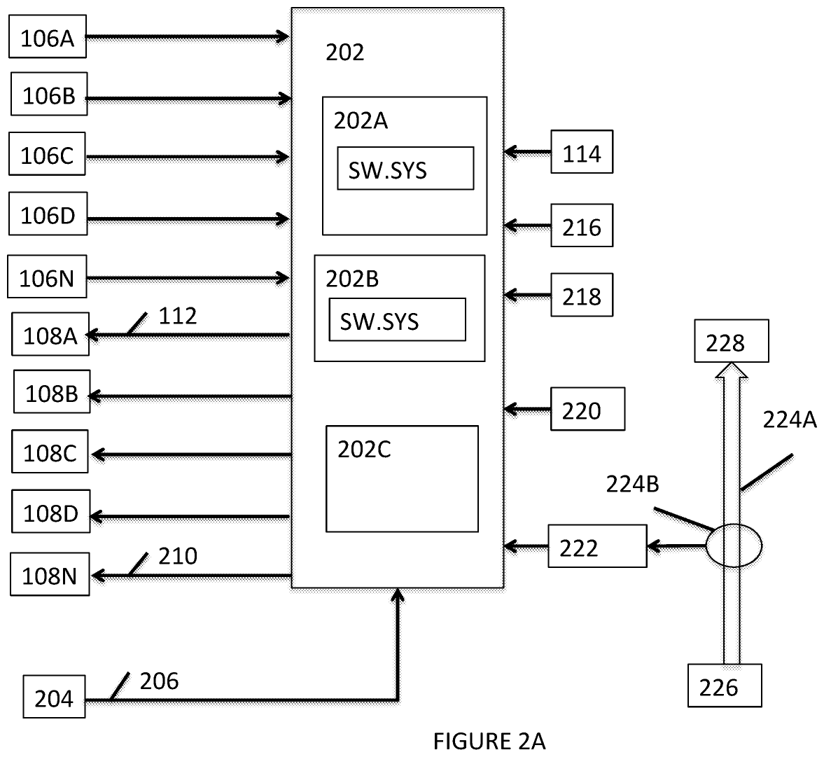

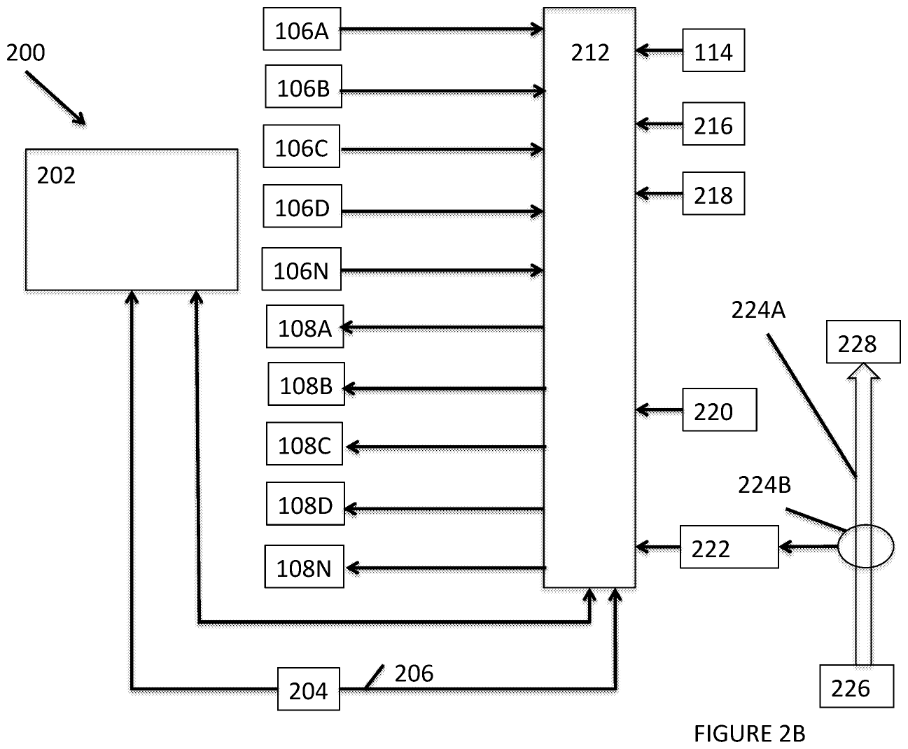

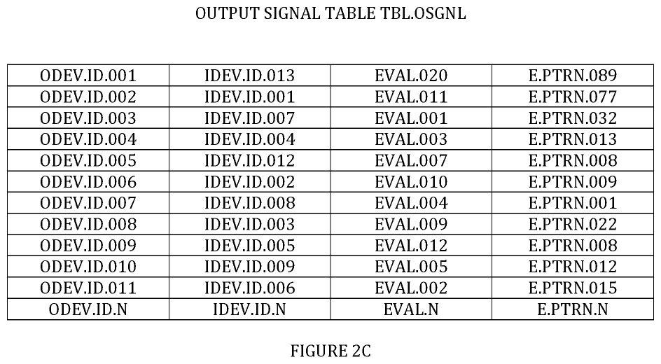

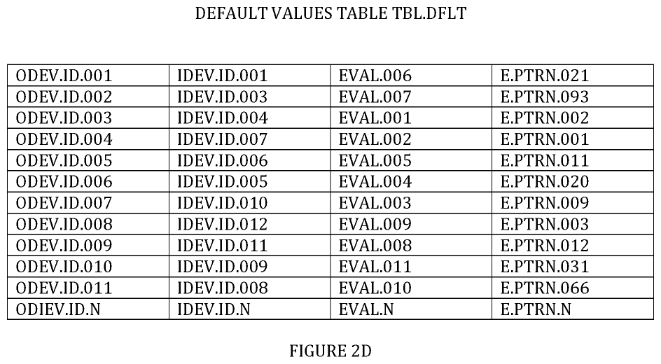

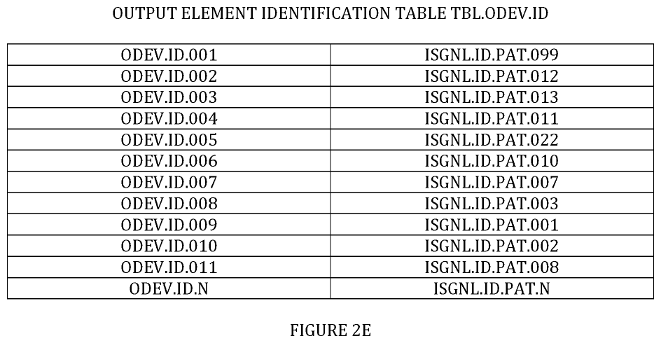

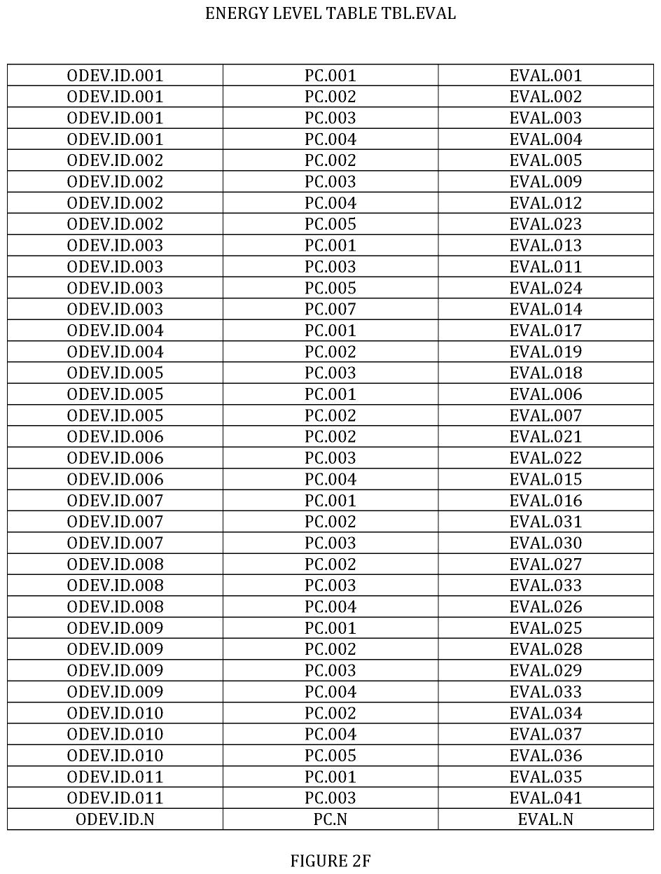

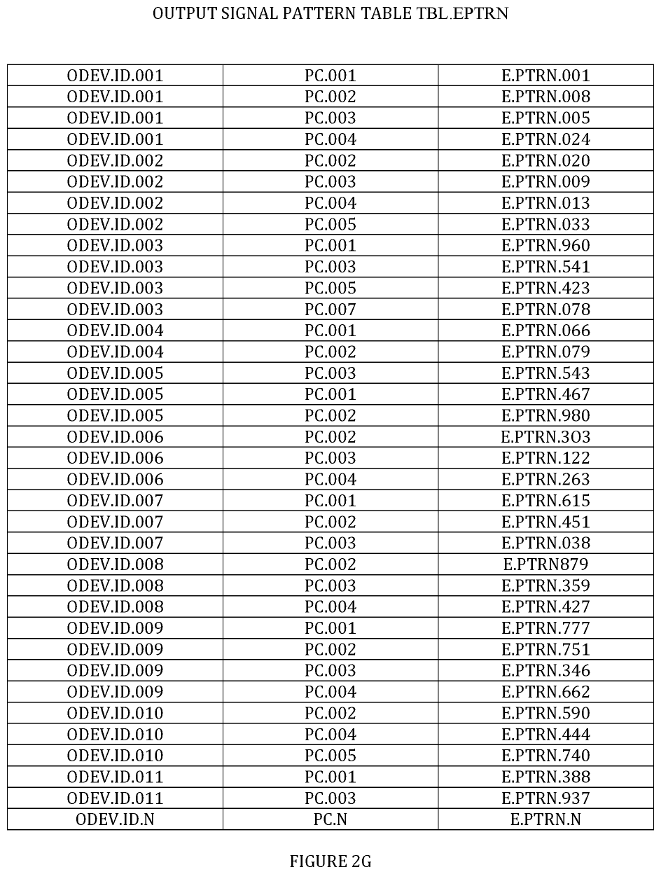

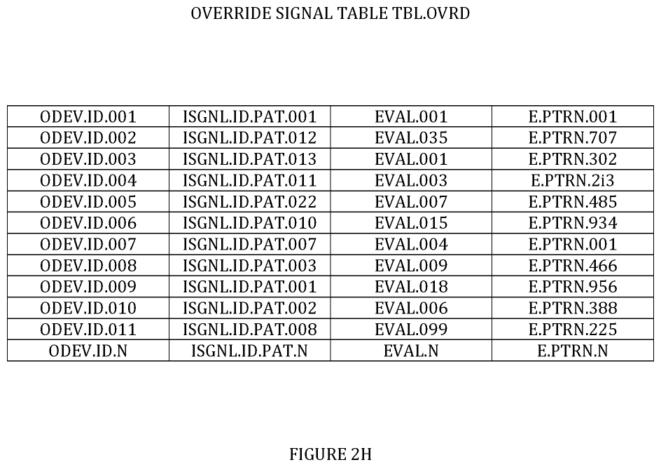

Referring now generally to the Figures and particularly to FIG. 2A, FIG. 2A is a block diagram of the first system 100 and with an invented control system 200 integrated therewith. The invented control system 200 includes a reprogrammable controller 202 and an electrical power supply 204. The electrical power supply may be native to the product 102 or newly coupled with the product 102 with the integration of the reprogrammable controller 202 with the product and/or the first system 100.

Where the invented control system 200 is integrated with or comprised within a motorized vehicle, one or more of the plurality of user actuated input elements 106A-106N may be or comprise a turn signal actuator, manually actuated brake control, manually actuated clutch control, a manually actuated gear switch control, a hazard light control actuator, a fog light control actuator and/or a high beam light actuator. In addition, when the invented control system 200 is integrated with or comprised within a motorized vehicle, one or more of the plurality of the output elements 108A-108N may be or comprise a turn signal, a vehicular brake, a clutch, a gear switch, a hazard light, a fog light and/or a high beam light.

The electrical power supply 204 may be an electrical storage battery or other suitable device known in the art that is adapted to provide electrical power to the reprogrammable controller 202 via an input power line 206. The reprogrammable controller 202 is adapted to controllably direct electrical power received via the input power 204 separately to both (1.) the light emitting element 108A via a first output power line 206; and (2.) to a system light emitting element 208 via a second output power line 210.

The reprogrammable controller 202 is communicatively coupled with the user actuated input elements 106A-106D that are native to the product 102. One or more user actuated input elements 106A-106D may be directly communicatively coupled with the reprogrammable controller 202.

The invented control system 200 may optionally be communicatively coupled with the operational state indication module 114.

The reprogrammable controller 202 may include a flash memory module 202A that preferably stores a default values table TBL.DFLT and a random access solid state memory 202B that preferably stores an output signal table TBL.OSGNL, an output element identification table TBL.ODEV.ID, an energy level table TBL.EVAL, and an output signal pattern table TBL.EPTRN.

It is understood that the flash memory module 202A and/or the random access solid state memory 202B of the reprogrammable controller 202 may further comprise a system software SW. SYS that is encoded or codec with commands and information sufficient to enable the reprogrammable processor 202 to instantiate and execute the aspects and steps of the invented method and the invented control system 200 disclosed herein.

It is understood that the reprogrammable controller 202 may further comprise a logic circuit 202C that may be configurable, reconfigurable, programmable and/or reprogrammable and that the logic circuit 202C may be encoded with commands and information sufficient to enable the reprogrammable processor 202 to instantiate and execute the aspects and steps of the invented method and the invented control system 200 disclosed herein.

Referring now generally to the Figures and particularly to FIG. 2B, FIG. 2B is a block diagram of additional optional features of the invented control system 200. The reprogrammable controller 202 is additionally bi-directionally communicatively coupled with the system elements 106A-106N & 108A-108N via a power and communications bus 212. The power and communications bus 212 may be or comprise a CAN-BUS system as marketed by BMW of Munich, Germany.

The controller 104 and/or the reprogrammable controller 202 may be or comprise a PIC16F1509 ™ microcontroller marketed by Microchip Technology Inc. of Chandler, Ariz., or other suitable digital controller, microcontroller, processor, microprocessor or digital logic device known in the art.

An additional smart peripheral 214 is also bi-directionally coupled with the power and communications bus 212, wherein the smart peripheral 214 is separately coupled with the electrical power supply 204 via an additional power line 216 whereby the smart peripheral 214 draws operating power from the electrical power supply 204 without intermediation by the reprogrammable controller 202. The smart peripheral 214 is adapted to change its instantaneous operating state in accordance with commands, instructions, information and status signals received form the reprogrammable controller 202 and interpreted by internal logic of the smart peripheral 214.

An additional accelerometer 216 is communicatively coupled with the reprogrammable controller 202 via the power and communications bus 212. The accelerometer 216 may be or comprise a MMA8653FC™ 3-Axis, 10-bit digital accelerometer as marketed by Freescale Semiconductor of Austin, Tex., or other suitable digital accelerometer known in the art.

An optional vehicular ignition system 218 is also communicatively coupled with the reprogrammable controller 202 via the power and communications bus 212. An optional the reset button module 220 is additionally communicatively coupled with the reprogrammable controller 202 via the power and communications bus 212.

An optional power sensor 222 is coupled an electrical power transmission link 224A at a sensing node 224B to, wherein the electrical power transmission link 224 is a pathway of electrical power between an vehicular electrical power source 226 and a vehicular motor 228. The vehicular electrical power source 226 may be or comprise a suitable electrical power battery or grouping of electrical power batteries known in the art. It is understood that the vehicular motor 228 is disabled from generating vehicular movement until and unless sufficient electrical energy is being transferred via the electrical power transmission link 224 from the electrical power source 226. The optional power sensor 222 is adapted to measure the instantaneous degree of electrical power that the electrical power transmission link 224 is providing to the vehicular motor 228 as sourced from the electrical power source 226, and the optional power sensor 222 is further adapted to inform the reprogrammable controller 202 whether the sufficient electrical energy is presently being transferred via the electrical power transmission link 224 from the electrical power source 226 and to the vehicular motor 228 to enable the motor 228 to generate vehicular movement.

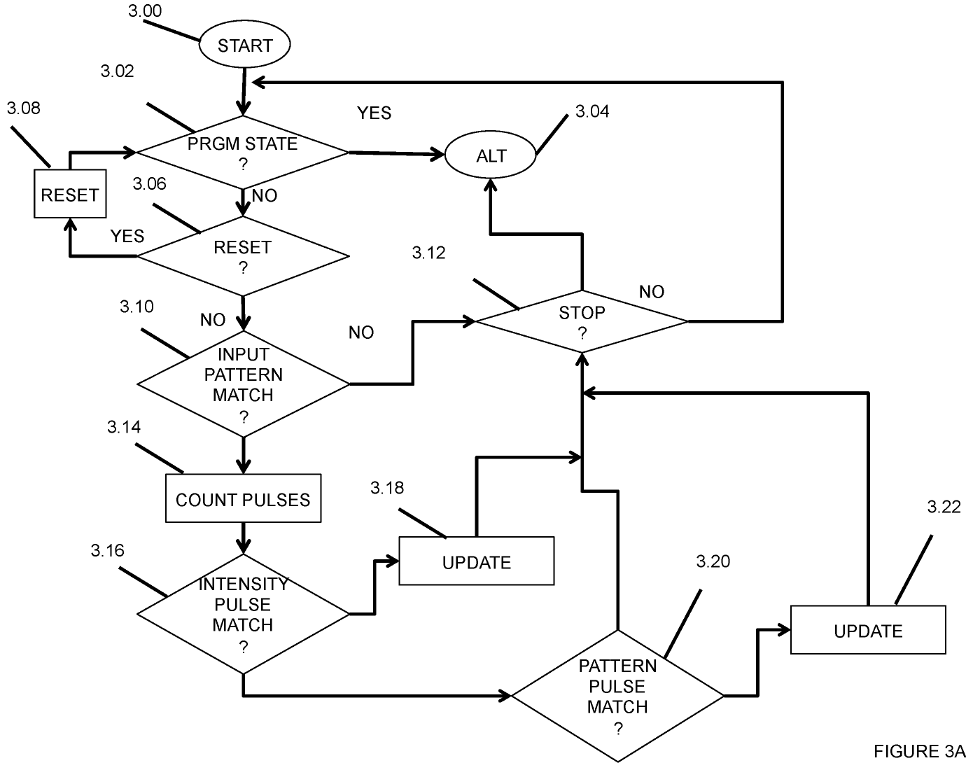

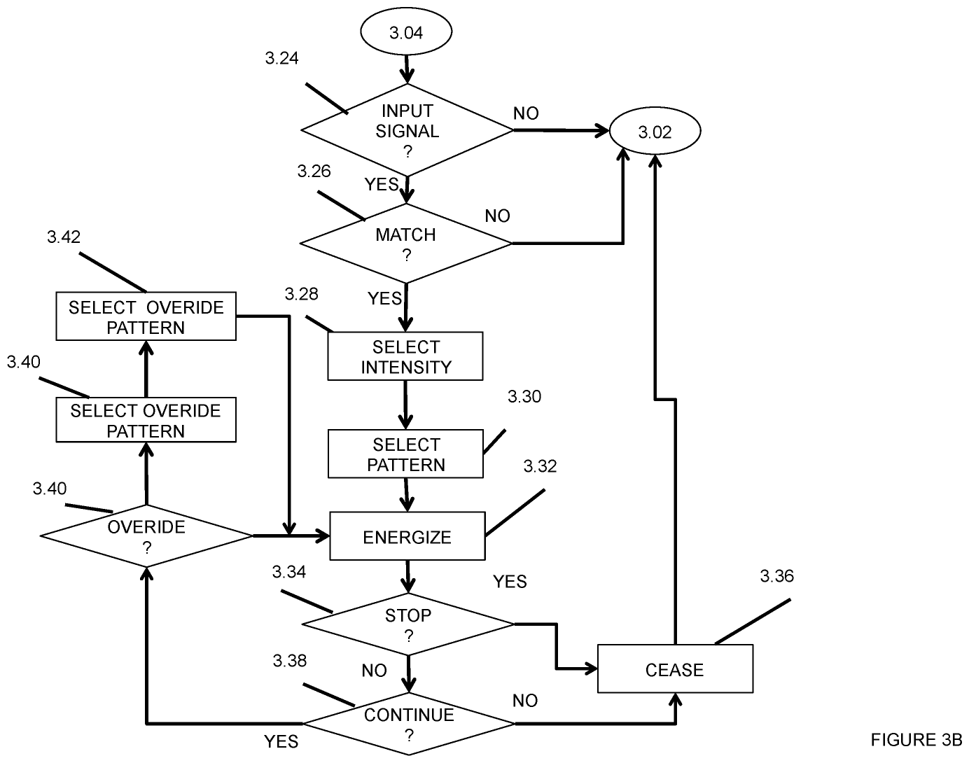

In certain alternate preferred embodiments of the invented method, when the power sensor 222 informs the reprogrammable controller 202 at step 3.02 of the method of FIG. 3A that sufficient electrical energy is presently being transferred via the electrical power transmission link 224 from the electrical power source 226 and to the vehicular motor 228 to enable the vehicular motor 228 to generate vehicular movement, the reprogrammable controller 202 proceeds from step 3.02 to step 3.04.

In the alternative, in these or other certain alternate preferred embodiments of the invented method, when the power sensor 222 informs the reprogrammable controller 202 at step 3.02 of the method of FIG. 3A that insufficient electrical energy is presently being transferred via the electrical power transmission link 224 from the electrical power source 226 and to the vehicular motor 228 to enable the vehicular motor 228 to generate vehicular movement, the reprogrammable controller 202 proceeds from step 3.02 to step 3.06.

It is understood that in certain still other alternate preferred embodiments of the invented method, wherein the electrical power transmission link 224 is a pathway of electrical power between the electrical power source 226 and the motor 228, wherein the electrical power transmission link 224, the electrical power source 226 and/or the motor 228 are not comprised within nor are coupled with a vehicle, but rather are comprised within and/or coupled with any of a wide variety of appliances, systems, or devices that employ or include electrically powered elements.

Referring now generally to the Figures and particularly to FIG. 2C, FIG. 2C is a block diagram of the output signal table TBL.OSGNL. Each row of the output signal table TBL.OSGNL associates (a.) one output element identifier ODEV.ID.001-ODEV.ID.N that identifies an individual output element 108A-108D in a unique one-to-one paired association with (b.) one input element identifier IDEVID.001-IDEVID.N that identifies an individual input element 106A-106D in a unique one-to-one paired, whereby pulses received from the input element 106A-016D referenced by the input element identifier IDEV.ID.001-IDEV.ID.N of a given row are applied by the reprogrammable controller 202 to energize referenced output element 108A-108D referenced by output element identifier ODEV.ID.001-ODEV.ID.N of said row when the product 102 is determined by the reprogrammable controller 202 to be in an operational mode rather than a programming mode.

In addition, each individual row of the output signal table TBL.OSGNL preferably associates each output element identifier ODEV.ID.001-ODEV.ID.N with an energy intensity value EVAL.001-EVAL.N and an energizing pattern E.PTRN.001-E.PTRN.N, whereby the reprogrammable controller 202 provides energy, i.e., electrical power, to the associated output element 108A-108.N (a.) at an intensity associated with the energy intensity value EVAL.001-EVAL.N of the same row; and (b.) in timing pattern of intermittent pulses or steady state energy value in accordance with the energizing pattern E.PTRN.001-E.PTRN.N of the same row.

Referring now generally to the Figures and particularly to FIG. 2D, FIG. 2D is a block diagram of the default values table TBL.DFLT that is applied in step 3.08 of FIG. 3A. The default values table TBL.DFLT associates each output element identifier ODEV.ID.001-ODEV.ID.N with a set of default values that are applied to, e.g., written into or pointed to, from the output signal table TBL.OSGNL, upon detection by the reprogrammable controller 202 of a reset signal received from the reset button module 220. These default values preferably include at least one input element identifier IDEV.ID.001-IDEV.ID.N, one energy intensity value EVAL.001-EVAL.N and one energizing pattern E.PTRN.001-E.PTRN.N.

Referring now generally to the Figures and particularly to FIG. 2E, FIG. 2E is a block diagram of the output element identification table TBL.ODEV.ID that is applied in step 3.10 of the method of FIG. 3A. Each row of the output element identification table TBL.ODEV.ID associates one output element identifier ODEV.ID.001-ODEV.ID.N with at least one pattern of input signals ISGNL.PAT.001-ISGNL.PAT.N, whereby when the reprogrammable controller 202 determines that a matching input signals pattern ISGNL.PAT.001-ISGNL.PAT.N has been detected in step 3.10 of the method of FIG. 3, the reprogrammable controller 202 proceeds to enable a new association of the output element identifier ODEVID.001-ODEVID.N referenced in the same row with (in step 3.18) an alternate energy intensity value EVAL.001-EVAL.N and/or (in step 3.22) with an alternate energizing pattern E.PTRN.001-E.PTRN.N.

Referring now generally to the Figures and particularly to FIG. 2F, FIG. 2F is a block diagram of the energy level table TBL.EVAL applied in step 3.18. Each row of the energy level table TBL.EVAL includes one output element identifier ODEV.ID.001-ODEV.ID.N, a pulse count PC.001-PC.N, and one energy intensity value EVAL.001-EVAL.N.

Referring now generally to the Figures and particularly to FIG. 2G, FIG. 2G is a block diagram of the output signal pattern table TBL.EPTRN applied in step 3.22. Each row of the output signal pattern table TBL.EPTRN includes one output element identifier ODEV.ID.001-ODEV.ID.N, a pulse count PC.001-PC.N, and one energizing pattern E.PTRN.001-E.PTRN.N.

Referring now generally to the Figures and particularly to FIG. 2H, FIG. 2H is a block diagram of the override signal table TBL.OVRD that is accessed and applied in steps 3.32, 3.40, 3.42, 3.44 of the method of FIG. 3B. Each row of the override signal table TBL.OVRD associates one output element identifier ODEV.ID.001-ODEV.ID.N with at least one pattern of input signals ISGNL.PAT.001-ISGNL.PAT.N, whereby when the reprogrammable controller 202 determines that a matching input signals pattern ISGNL.PAT.001-ISGNL.PAT.N has been detected in step 3.40 of the method of FIG. 3B, i.e. during non-programming state of the product 102, the reprogrammable controller 202 proceeds to access and apply an override power intensity and a time sequence energizing pattern to the output element identifier ODEV.ID.001-ODEV.ID.N referenced in the same row, wherein an override energy intensity value EVAL.001-EVAL.N of this same row is accessed in step 3.42 and applied in the next execution of step 3.32, and an override energizing pattern E.PTRN.001-E.PTRN.N of this same row is accessed in step 3.4 and applied in the same next aforementioned execution of step 3.32.

Referring now generally to the Figures and particularly to FIG. 3A, FIG. 3A is a flow chart of a process of reprogramming the invented control system 200. In step 3.00 the invented control system 200 is powered up and becomes available for communications with the actuated input elements 106A-106D. In step 3.02 the reprogrammable controller 202 determines whether an operational status signal has been received from the operational state indication module 114 indicating whether the product 102 is a state that enables reprogramming of the reprogrammable controller 202.

When the reprogrammable controller 202 determines that it has not received a confirming operational status signal in step 3.02 indicating that the invented control system 200 is enabled to reprogram the reprogrammable controller 202, the reprogrammable controller 202 proceeds on to alternate operations of step 3.04.

Where the product 100 is a motorized vehicle and the reprogrammable controller 202 is coupled with the accelerometer 216, the reprogrammable controller 202 will determine that the invented control system 200 is not available for the reprogramming aspects of FIG. 3A when the accelerometer 216 informs the reprogrammable controller 202 the product 100 is presently accelerating or decelerating, and the reprogrammable controller 202 will proceed from step 3.02 to step 3.04.

Optionally, where the product 100 is a motorized vehicle and the reprogrammable controller 202 is coupled with the accelerometer 216 of the product 100, the reprogrammable controller 202 will determine that the invented control system 200 is available for the reprogramming aspects of FIG. 3A when the accelerometer 216 informs the reprogrammable controller 202 that the product 100 is neither accelerating nor decelerating, and the reprogrammable controller 202 will thereupon proceed from step 3.02 to step 3.06.

Where the product 100 is a motorized vehicle and the reprogrammable controller 202 is coupled with the ignition module 218, the reprogrammable controller 202 will determine that the invented control system 200 is not available for the reprogramming aspects of FIG. 3A when the ignition module 218 informs the reprogrammable controller 202 the product 100 is presently enabled to generate motorized power, and the reprogrammable controller 202 will thereupon proceed from step 3.02 to step 3.04.

Optionally, where the product 100 is a motorized vehicle and the reprogrammable controller 202 is coupled with the ignition module 218 of the product 100, the reprogrammable controller 202 will determine that the invented control system 200 is available for the reprogramming aspects of FIG. 3A when the ignition module 218 informs the reprogrammable controller 202 that the product 100 is presently not enabled to generate, or is presently disabled from generating, motorized power, and the reprogrammable controller 202 will thereupon proceed from step 3.02 to step 3.06.

When the reprogrammable controller 202 determines that it has received a confirming operational status signal in step 3.02 indicating that the invented control system 200 is enabled to reprogram the reprogrammable controller 202, the reprogrammable controller 202 proceeds on to alternate operations of step 3.06 and determines whether a reset signal has been received from the rest button module 220.

When the reprogrammable controller 202 determines in step 3.06 that a reset signal has been received from the reset button module 220, the reprogrammable controller 202 resets the output signal table TBL.OSGNL to the hold the values of stored output default values table TBL.DFLT in step 3.08 and proceeds from step 3.08 to another execution of step 3.02. When the reprogrammable controller 202 determines in step 3.06 that a reset signal has not been received from reset button, the reprogrammable controller 202 proceeds to step 3.10 and determines if a pattern of input signals ISGNL.PAT.001-ISGNL.PAT.N presently detected by the reprogrammable controller 202 as sent from the user actuated input elements 106A-106D matches a pattern of input signals ISGNL.PAT.001-ISGNL.PAT.N previously stored in the output element identification table TBL.ODEV.ID. When the reprogrammable controller 202 determines in step 3.10, the that an input signal pattern ISGNL.PAT.001-ISGNL.PAT.N as sent from the user actuated input elements 106A-106D IN STEP 3.10 does not any match any pattern of input signals ISGNL.PAT.001-ISGNL.PAT.N previously stored in the output element identification table TBL.ODEV.ID, the reprogrammable controller 202 proceeds on to step 3.12 and determines in step 3.12 whether to proceed back to another execution of step 3.02, or in the alternative to proceed on to alternate computational operations of step 3.04.

When the reprogrammable controller 202 determines in step 3.10, that a pattern of input signals ISGNL.PAT.001-ISGNL.PAT.N as received from one or more the user actuated input elements 106A-106D does match pattern of input signals ISGNL.PAT.001-ISGNL.PAT.N previously stored in the output element identification table TBL.ODEV.ID, the reprogrammable controller 202 proceeds on to step 3.14 and counts pulses, i.e., generates a pulse count PC.001-PC.N, received from a designated input element 106A-106D associated with the element identifying pattern ODEV.ID.PAT.001-ODEV.ID.PAT.N within a time period T1.

In step 3.16 the reprogrammable controller 202 determines if the pulse count PC.001-PC.N calculated in step 3.14 in combination with the selected output element identifier ODEV.ID.001-ODEV.ID.N matched in step 3.10 is associated with an energy intensity value energy EVAL.001-EVAL.N in the energy intensity value table TBL.EN.

When the reprogrammable controller 202 determines that the pulse count PC is associated with an energy intensity value EVAL.001-EVAL.N, the reprogrammable controller 202 proceeds to step 3.18 and updates the row of the output signal table TBL.OSGNL associated with the output element identifier ODEV.ID.001-ODEV.ID.N selected in step 3.10 with the associated energy intensity value EVAL.001-EVAL.N. The reprogrammable controller 202 proceeds from step 3.18 to step 3.12.

When the reprogrammable controller 202 determines in step 3.16 that the pulse count PC in combination with the selected output element identifier ODEVID.001-ODEVID.N of step 3.10 is not associated with an energy intensity value EVAL.001-EVAL.N, the reprogrammable controller 202 proceeds on to step 3.20 to determine if the pulse count PC in combination with the selected output element identifier ODEV.ID.001-ODEVID.N is associated with an energizing pattern E.PTRN.001-E.PTRN.N stored in the output signal pattern table TBL.EPTRN.

When the reprogrammable controller 202 determines in step 3.20 that the pulse count PC in combination with the selected output element identifier ODEV.ID.001-ODEV.ID.N is associated with an energizing pattern E.PTRN.001-E.PTRN.N, the reprogrammable controller 202 proceeds to step 3.22 and updates the row of the output signal table TBL.OSGNL associated with the output element identifier ODEV.ID.001-ODEV.ID.N matched in step 3.10 with the energizing pattern E.PTRN.001-E.PTRN.N identified in step 3.20. The reprogrammable controller 202 proceeds from either step 3.20 or step 3.22 to step 3.12.

Referring now generally to the Figures and particularly to FIG. 3B, FIG. 3B is a flow chart of a process of the invented control system 200 performing in accordance with the reprogramming executed in an instantiation of the flow chart of FIG. 3A.

The reprogrammable controller 202 proceeds from step 3.04 to step 3.24 and determines if an input signal has been received from an input element 106A-106D, and if no input signal is determined in step 3.24, the reprogrammable controller 202 proceeds on to step 3.02. In the alternative, when the reprogrammable controller 202 determines in step 3.24 that an input signal has been received from an input element 106A-106D, the reprogrammable controller 202 proceeds on to step 3.26 and to determine if the input signal received from any input element identifier IDEV.ID.001-IDEV.ID.N stored in the output signal table TBL.OSGNL. When a match between an input element identifier IDEV.ID.001-IDEV.ID.N found in any row of the output signal table TBL.OSGNL, the reprogrammable controller 202 proceeds on to step 3.28 to select the energy intensity value EVAL.001-EVAL.N of the selected row, and to select the time sequence energizing pattern E.PTRN.001-E.PTRN.N of the same selected row in step 3.20.

In step 3.32, the reprogrammable controller 202 then applies the energy intensity value EVAL.001-EVAL.N and the time sequence energizing pattern E.PTRN.001-E.PTRN.N to energize the output element 108A-108D identified in the row of output signal table TBL.OSGNL the selected in step 3.26. The reprogrammable controller 202 determines in step 3.34 the reprogrammable controller 202 whether to cease energizing the output element 108A-108D selected in step 3.32, and when the reprogrammable controller 202 determines to cease energizing the output element 108A-108D selected in step 3.32 proceeds on to cease energizing the selected output element 108A-108D in step 3.36. The reprogrammable controller 202 proceeds from step 3.38 back to perform an additional execution of step 3.02.

In the alternative, when the reprogrammable controller 202 determines to not cease energizing the output element 108A-108D selected in step 3.32, the reprogrammable controller 202 proceeds on to step 3.38 and determines whether to continue energizing the output element 108A-108D selected in step 3.32.

When the reprogrammable controller 202 determines in step 3.38 to continue energizing the output element 108A-108D selected in step 3.32, the reprogrammable controller 202 proceeds on to step 3.40 and applies the information and values of the override signal table TBL.OVRD to determine, in this operational and non-programming mode of the product 102, whether an input element signal pattern ISGNL.001-ISGNL.N indicating a override signaling command has been received. Referring now to FIG. 2H, each row of the override signal table TBL.OVRD associates one output element identifier ODEV.ID.001-ODEV.ID.N with at least one pattern of input signals ISGNL.PAT.001-ISGNL.PAT.N, one override power intensity value EVAL.001-EVAL.N and one energizing pattern E.PTRN.001-E.PTRN.N. When the reprogrammable controller 202 determines in step 3.40 that a matching input signals pattern ISGNL.PAT.001-ISGNL.PAT.N of a given row of the override signal table TBL.OVRD is being received by the reprogrammable controller 210, during this non-programming state of the product 102, the reprogrammable controller 202 proceeds from step 3.40 to step 3.42 to access an override power intensity value EVAL.001-EVAL.N of this same row of the override signal table TBL.OVRD selected in step 3.40 and therefrom to step 3.44. to select an energizing pattern E.PTRN.001-E.PTRN.N of this same row of the override signal table TBL.OVRD selected is accessed in step 3.44. The override power intensity value EVAL.001-EVAL.N and the energizing pattern E.PTRN.001-E.PTRN.N and applied in the next execution of step 3.32 to energize and excite the output element associated with the one output element identifier ODEVID.001-ODEVID.N included in the same row of the override signal table TBL.OVRD selected in step 3.40.

In the alternative, when the reprogrammable controller 202 determines in step 3.38 to not continue energizing the output element 108A-108D selected in step 3.32, the reprogrammable controller 202 proceeds on to step 3.36.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or manufacturing processes described herein may be performed or implemented with one or more hardware or software modules, alone or in combination with other devices. In one embodiment, a software module is implemented with a computer program product comprising a non-transitory computer-readable medium containing computer program code, which can be executed by a computer aided manufacturing system for fabricating the invented device and/or performing any or all of the steps, operations, or processes described. This apparatus may be specially constructed for the required purposes. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to an apparatus for performing the operations herein. Embodiments of the invention may also relate to a product that is produced by a manufacturing process described herein. Such a product may comprise information resulting in part from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based herein. Accordingly, the disclosure of the embodiments of the invention is intended to be illustrative, but not limiting, of the scope of the invention, which is set forth in the following claims.

What is claimed is:

1. A device coupled with a vehicular control system of a vehicle, the vehicular control system of a vehicle having a battery, a turn signal actuator, a user actuated pulse generator and a light emitting element, the device comprising:
a reprogrammable controller receiving electrical power from the battery and communicatively coupled with both the turn signal actuator and the user actuated pulse generator, the controller adapted for receiving control signals from the turn signal actuator and for reprogramming by the user actuated pulse generator, whereby the controller is configured to transfer electrical power to energize the light emitting element as reprogrammed by pulses received from the user actuated pulse generator; and
a power signal channel coupled to the controller and the light emitting element, whereby electrical power controllably transferred through the controller is delivered to the light-emitting element.

2. The device of claim 1, wherein the vehicular control system further includes an ignition module coupled with a motor of the vehicle, and the ignition module generates an ignition state signal that indicates when the motor is enabled to provide power to drive the vehicle, the device further comprising an ignition state signal channel communicatively coupled with the controller and the ignition module and ignition state signal channel for providing the ignition state signal to the controller, whereby the controller is disabled from reprogramming when the ignition state signal indicates that the motor is enabled to provide power to drive the vehicle.

3. The device of claim 2, wherein the user actuated pulse generator is comprised within the turn signal actuator.

4. The device of claim 1, wherein the user actuated pulse generator is comprised within a manually actuated brake control.

5. The device of claim 1, wherein the user actuated pulse generator is comprised within a manually actuated clutch control.

6. The device of claim 1, wherein the user actuated pulse generator is comprised within a user actuated pulse generator selected from the group of user actuated pulse generators consisting of a manually actuated gear switch control, a hazard light control actuator, a fog light control actuator and a high beam light actuator.

7. The device of claim 1, wherein the vehicular control system further includes a motion indicator coupled with a motor of the vehicle, and the motion indicator provides a motion state signal that indicates when the vehicle is in motion, and the device further comprises a motion state signal channel communicatively coupled with the controller and the motion indicator, and the motion state signal channel provides the motion signal to the controller when the vehicle is in motion, whereby the controller is disabled from reprogramming when motion indicator signal indicates that the motor is in motion.

8. The device of claim 7, wherein the motion indicator generates the motion state signal when an element of the motor is generating electrical power.

9. The device of claim 7, wherein the motion indicator comprises an accelerometer.

10. The device of claim 9, wherein the accelerometer is comprised within the device.

11. The device of claim 1, wherein the controller is reprogrammed to selectively cause the light emitting element to intermittently flash at a reprogrammed frequency.

12. The device of claim 11, wherein the controller is reprogrammed to selectively cause the light emitting element to intermittently flash at an alternate reprogrammed frequency.

13. The device of claim 1, wherein the controller is reprogrammed to selectively cause the light emitting element to maintain a steady state lumen intensity.

14. The device of claim 1, wherein the controller is reprogrammed to determine a power level to selectively cause the light emitting element to intermittently flash at a reprogrammed frequency.

15. The device of claim 1, wherein the controller is reprogrammed to determine a power level to selectively cause the light emitting element to maintain a steady state lumen intensity.

16. The device of claim 1, wherein the controller is reprogrammed to override an instant state of the light emitting element and deliver electrical power to cause the light emitting element to exhibit a programmed state.

17. The device of claim 1, wherein the light-emitting element comprises a light emitting diode.

18. The device of claim 1, wherein the light-emitting element is comprised within the device.

19. The device of claim 1, wherein the controller includes a reset logic that provides a default logic applied to transfer electrical power to energize the light-emitting element.

20. A method for reprogramming a control logic as applied to a vehicular light element, the method comprising:
electrically coupling a controller to a battery and a light-emitting element;
communicatively coupling the controller to a user actuated light element control and to a user actuated pulse generator;
programming the controller by means of a user generating pulses from the user actuated pulse generator;
providing the controller with control signals generated from the user actuated light element control; and
providing electrical power to the light-emitting element via the controller and in accordance with both the programming of the controller and the control signals received from the user actuated light element control by the controller.
